(19) United States
(12) Patent Application Publication
(10) Pub. No.: US 2024/0232898 A1
(43) Pub. Date: Jul. 11, 2024

(54) AUTOMATICALLY CREATING RECURRING TRANSACTIONS

(71) Applicant: INTUIT INC., Mountain View, CA (US)

(72) Inventors: Lior TABORI, Tel-Aviv (IL); Ido Meir MINTZ, Tel-Aviv (IL); Hagay FINE, Herzliya (IL); Alex ZICHAREVICH, Petah Tikva (IL)

(21) Appl. No.: 18/151,258

(22) Filed: Jan. 6, 2023

(51) Int. Cl. G06Q 20/40; G06N 20/00

(52) U.S. Cl. CPC G06Q 20/405; G06N 20/00

(57) ABSTRACT

The present disclosure provides techniques for recommending vendors using machine learning models. One example method includes generating a set of features based on a sequence of recurring transactions associated with a user, a payee, and a transaction amount, predicting simultaneously, using a machine learning model based on the set of features, that the sequence of recurring transactions will continue with a subsequent transaction and a time window within which the subsequent transaction of the sequence will occur, receiving electronic transaction data indicative of a transaction associated with the user, the payee, and the transaction amount, indicating that the transaction is the subsequent transaction in the sequence of recurring transactions based on the transaction and the prediction, and automatically creating one or more future recurring transactions based on the indication.

### INTRODUCTION

Aspects of the present disclosure relate to automatically creating recurring transactions.

Electronic transactions have become increasingly popular, especially as more and more consumers and businesses utilize online exchange platforms or online payment services. An electronic transaction can indicate a user (e.g., a payer), a payee (e.g., a merchant), and a transaction amount. Many of the electronic transactions can be recurring payments that have a certain recurrence rate (e.g., weekly, monthly, quarterly, yearly and so on).

However, in many cases, a sequence of recurring electronic transactions, especially a sequence of recurring business-to-business (B2B) transactions, do not share an exact periodicity. For example, for a monthly recurring payment scheme, a user may choose to pay the payee earlier or later than an expected payment date due to cash flow issues. Accordingly, the inconsistencies in periodicity can cause confusion for both payers and payees.

An electronic transaction often does not include enough information to help determine whether the transaction is a part of a sequence of recurring transactions through conventional automated analysis techniques. It is even more difficult for a software application to predict when a recurring transaction will happen. For example, existing techniques, such as time series analysis, can only predict whether a sequence of recurring transactions will continue or a next occurrence for the sequence, but not both simultaneously. In addition, the existing techniques require a long history of transactions to have accurate predictions.

Accordingly, improved systems and methods are needed for automatically creating recurring transactions.

### BRIEF SUMMARY

Certain embodiments provide a method for automatically creating recurring transactions. The method generally includes generating a set of features based on a sequence of recurring transactions associated with a user, a payee, and a transaction amount, predicting simultaneously, using a machine learning model based on the set of features, that the sequence of recurring transactions will continue with a subsequent transaction and a time window within which the subsequent transaction of the sequence will occur, receiving electronic transaction data indicative of a transaction associated with the user, the payee, and the transaction amount, indicating that the transaction is the subsequent transaction in the sequence of recurring transactions based on the transaction and the prediction, and automatically creating one or more future recurring transactions based on the indication.

Another embodiment provides a system for automatically creating recurring transactions. The system generally includes a memory including computer-executable instructions and a processor configured to execute the computer-executable instructions. Executing the computer executable-instructions causes the system to generate a set of features based on a sequence of recurring transactions associated with a user, a payee, and a transaction amount, predict simultaneously, using a machine learning model based on the set of features, that the sequence of recurring transactions will continue with a subsequent transaction and a time window within which the subsequent transaction of the sequence will occur, receive electronic transaction data indicative of a transaction associated with the user, the payee, and the transaction amount, indicate that the transaction is the subsequent transaction in the sequence of recurring transactions based on the transaction and the prediction, and automatically create one or more future recurring transactions based on the indication.

Still another embodiment provides a non-transitory computer readable medium for automatically creating recurring transactions. The non-transitory computer readable medium generally includes instructions to be executed in a computer system, wherein the instructions when executed in the computer system perform a method for automatically creating recurring transactions on a computing device requiring minimal run time processing. The method generally includes generating a set of features based on a sequence of recurring transactions associated with a user, a payee, and a transaction amount, predicting simultaneously, using a machine learning model based on the set of features, that the sequence of recurring transactions will continue with a subsequent transaction and a time window within which the subsequent transaction of the sequence will occur, receiving electronic transaction data indicative of a transaction associated with the user, the payee, and the transaction amount, indicating that the transaction is the subsequent transaction in the sequence of recurring transactions based on the transaction and the prediction, and automatically creating one or more future recurring transactions based on the indication.

The following description and the related drawings set forth in detail certain illustrative features of the various embodiments.

### BRIEF DESCRIPTION OF DRAWINGS

The appended figures depict certain features of the various aspects described herein and are not to be considered limiting of the scope of this disclosure.

FIG. 1 depicts an example transaction creator for automatically creating recurring transactions.

FIG. 2 depicts an example model trainer for automatically creating recurring transactions.

FIG. 3 depicts an example set of features for time window generation.

FIG. 4 is a flow diagram of example operations for automatically creating recurring transactions.

FIG. 5 depicts an example application server related to embodiments of the present disclosure.

### DETAILED DESCRIPTION

Aspects of the present disclosure provide apparatuses, methods, processing systems, and computer-readable mediums for automatically creating recurring transactions.

Recurring transactions can be made earlier or later than expected due to various constraints or errors. Factors such as human preferences, real world constraints, and differences in numbers of days in a month can introduce temporal variations in when recurring transactions are made. Recurring transactions in a sequence generally share a rate of recurrence, also known as a periodicity (e.g., weekly, monthly, quarterly, yearly and so on). For example, for monthly recurring transactions, the recurring transactions usually do not occur once every 30 days. In fact, given the factor of different months alone, the recurring transactions can occur once every 30 days, once every 31 days, or sometimes once every 28 or 29 days (e.g., in case of February). Temporal variation between consecutive recurring transactions in a sequence of recurring transactions can mask the true rate of recurrence, making recognizing the sequence of recurring transactions challenging.

Untimely occurrences of supposedly recurring transactions can cause confusion to payers and payees alike, hinder planning and cause problems in the exchanges of goods or services. Existing recurring transaction creation methods performed by software applications are insufficient for recognizing a sequence of recurring transactions in many cases, such as if the recurring transactions do not match an exact periodicity.

Embodiments of the present disclosure address these deficiencies in electronic transactions and resulting limitations in software applications that automatically create recurring transactions based on historical transaction data. Techniques described herein allow a software application to recognize that a transaction is a part of a sequence of recurring transactions even if the recurring transactions do not match an exact periodicity or exhibit other irregular characteristics.

According to certain embodiments, utilization of a time window accounts for temporal variations in recurring transactions. For example, a sequence of monthly recurring transactions can have a gap of 25 days to 35 days between consecutive transactions in the sequence, and a subsequent transaction in the sequence can be likely to happen within a time window of 25 days to 35 days after the most recent transaction in the sequence.

Machine learning techniques can be utilized to predict if a current electronic transaction is a subsequent transaction for a sequence of recurring transactions, and whether the current electronic transaction is within a time window during which the subsequent transaction will happen. In other words, the prediction can indicate whether a sequence has a subsequent transaction (e.g., a classification task), and if yes, when the subsequent transaction will occur (e.g., a regression task). In other words, the prediction indicates that if a transaction happens within the time window, the transaction is the subsequent transaction in the sequence. By consolidating a classification task and a regression task problem into a single classification task, significant amounts of computational and financial resources can be saved.

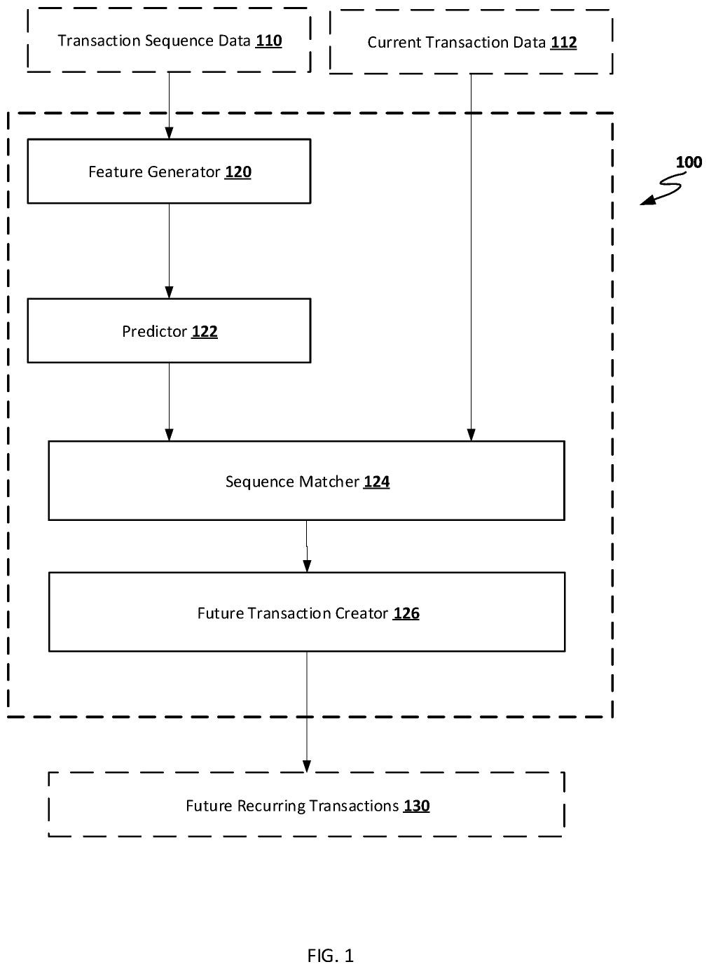

In some embodiments, the prediction is generated by a machine learning model based on a set of features computed for the sequence of recurring transactions. The set of features can include statistical descriptors for the sequence, information about the payer and/or the payee associated with the sequence, information generated based on certain heuristics, and/or other characteristics of the sequence. Firstly, temporal variations between consecutive recurring transactions can be normalized. In addition, some payees (e.g., supplier of goods or services) are more likely to be associated with recurring transactions, which may be determined based on historical transaction data, based on attributes of payees (e.g., payees of a certain type may be known to more commonly be associated with recurring transactions), and/or the like. Furthermore, a long sequence of recurring transactions can indicate an established and stable relationship between a user and a payee that is likely to continue. The sequence of recurring transactions can include two or more transactions for the set of features to be properly generated. Details regarding the set of features can be found below with respect to FIG. 1.

Accordingly, a machine learning model can be trained to predict whether a subsequent transaction will occur within a time window for a sequence of recurring transactions. If a later transaction matches the sequence (e.g., having the same user, the same payee, and the same amount of transaction) and occurs within the time window, the later transaction can be regarded as the subsequent transaction. The machine learning model can include a gradient-boosted tree classifier, a gradient-boosted machine classifier, or other classification models.

In some embodiments, the machine learning model performs batch predictions for a plurality of sequences of recurring transactions in a period (e.g., in a month) for real time inference in the upcoming period (e.g., in the upcoming month). The sequences predicted to have a subsequent transaction occurring within a time window can be stored in a database. When a transaction (e.g., referred to as a current transaction) is received in the upcoming period, the current transaction can be matched (e.g., through identifiers indicative of a user, a payee, an amount of the transaction, and/or the like) with a corresponding sequence stored beforehand. A binary indication can be generated based on whether the current transaction occurs within the time window (e.g., recognized as the subsequent transaction for the corresponding sequence). The binary indication can be used to create future recurring transactions sharing the same user, the same payee, the same amount of transaction, and/or the same or similar rate of recurrence with a given transaction in the sequence of recurring transactions.

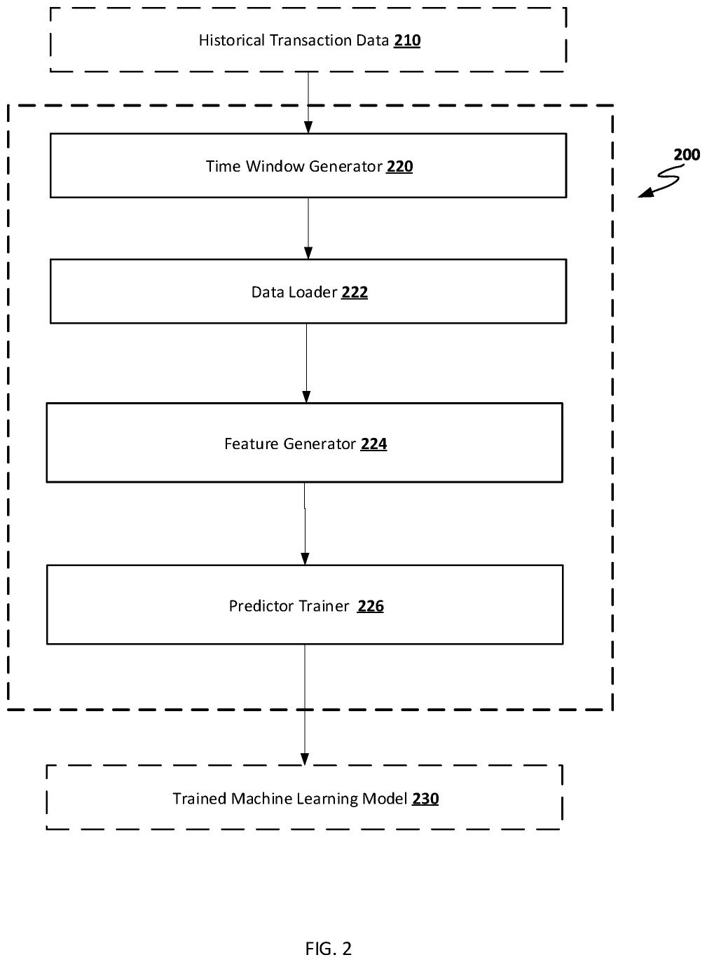

Historical sequences of recurring transactions can be used to generate training data to train the machine learning model. A cutoff time may be used to separate a historical sequence into training data and labeling data. The labeling data can be used to generate binary labels indicating whether or not a subsequent transaction happens within a time window for the sequence. The training data can be used to generate a set of features for each sequence. The sets of features can be combined with the labels to train the machine learning model. Details regarding training the machine learning model can be found below with respect to FIG. 2.

By using a machine learning model to predict whether a subsequent transaction will happen within a time window for a sequence of recurring transactions, techniques described herein overcome deficiencies in existing techniques for automatically creating recurring transactions. For example, while existing techniques may not recognize a sequence of recurring transactions due to temporal variations between consecutive recurring transactions, techniques described herein allow a computing application to account for the temporal variations through the use of a time window and machine learning techniques. Furthermore, by predicting based on sequences having a minimum of two recurring transactions rather than a long history of data required by existing methods such as time series analysis, techniques described herein require only a limited amount of information to make accurate predictions. Additionally, by consolidating a classification task and a regression task into a single task, techniques described herein help improve the efficiency in utilization of computing resources, thereby improving the functioning of the computing devices involved. Embodiments of the present disclosure also improve user experience by automatically creating recurring transactions that would require manual input otherwise, and facilitate efficiency in exchange of goods or services.

### Example Transaction Creator for Automatically Creating Recurring Transactions

FIG. 1 depicts an example transaction creator 100 for automatically creating recurring transactions. Transaction creator 100 can receive transaction sequence data 110 and current transaction data 112 as inputs and generate future recurring transactions 130 as the output. Transaction creator 100 can be deployed online or offline.

Transaction sequence data 110 can indicate a sequence of recurring transactions, such as in the form of electronic transaction records. Recurring transactions usually have fixed parties in exchange and a fixed amount of transaction. Transaction sequence data 110 can indicate information such as a user (e.g., through a user ID), a payee (e.g., through a payee ID), an amount of the transaction, and/or timestamps of the transactions. The timestamps for each transaction can include a timestamp indicating when the transaction is created (e.g., a creation timestamp) and when the transaction is due (e.g., a due timestamp, often represented as a due date). In some examples, the amount of the transaction is rounded to the nearest integer. In some examples, the sequence of recurring transactions includes two or more transactions.

Similarly, current transaction data 112 can indicate a current transaction (e.g. with a more recent timestamp than transactions in the sequence of recurring transactions), such as in the form of an electronic transaction record. Current transaction data 112 can indicate information such as a user (e.g., through a user ID), a payee (e.g., through a payee ID), an amount of the transaction, and/or timestamps of the current transaction, as discussed above with respect to transaction sequence data 110.

Transaction sequence data 110 can be provided as inputs to feature generator 120 to generate a set of features. The set of features can include statistical descriptors for the sequence, information about the user (e.g. the payer) or the payee associated with the sequence, and additional information. Some heuristics can help generate the additional information. Firstly, recurring transactions are usually associated with a rate of recurrence, also known as a periodicity (e.g., weekly, monthly, quarterly, yearly and so on). However, there can be temporal variations between consecutive transactions. For example, for a sequence of monthly recurring transactions, there can be fewer days apart between a February transaction and a March transaction than between the March transaction and an April transaction, because February has fewer days than other months in a year. In addition, some payees (e.g., supplier of goods or services) are more likely to be paid with recurring transactions. Furthermore, a long, established history of recurring transactions can indicate stable business relationship between a certain user and a certain payee, such that the transaction scheme is likely to continue.

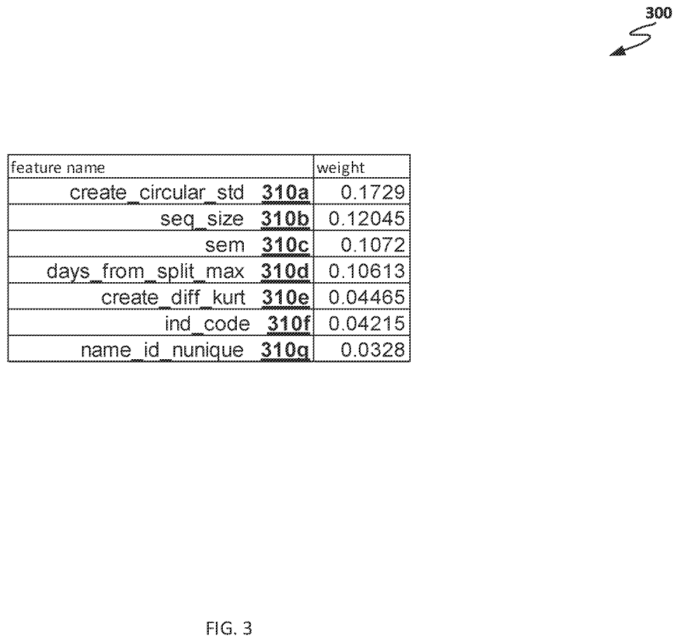

The set of features can include deltas between timestamps of consecutive transactions of the sequence of recurring transactions, deltas between due dates of consecutive transactions of the sequence of recurring transactions, statistical moments (e.g., mean, variance, skewness, kurtosis, and so on) of the deltas, periodic characteristics of the transactions (e.g., indications whether a transaction is created at the beginning of a period or at the end of a period) of the sequence of recurring transactions, an industry to which the payee belongs, a number of sequences associated with the payee, a standard deviation of scaled (e.g. normalized with respect to the period) timestamps of transactions of the sequence of recurring transactions, a number of transactions in the sequence of recurring transactions, a normalized standard deviation of the deltas between timestamps of consecutive transactions of the sequence of recurring transactions, and a duration between an earliest transaction and a latest transaction in the sequence of recurring transactions, and so on. Some features used in a machine learning model can be found below with respect to FIG. 3.

The set of features can be provided as inputs to predictor 122 to generate a prediction that indicates simultaneously that the sequence of recurring transactions will continue with a subsequent transaction and a time window within which the subsequent transaction of the sequence will occur. In other words, predictor 122 predicts whether the sequence of recurring transactions will have a subsequent transaction occurring within a time window. In some examples, if no subsequent transaction is predicted to happen within the time window for a sequence of recurring transactions by predictor 122, the sequence of recurring transactions is regarded as terminated and excluded from further operations.

The time window can be associated with the rate of occurrence of the sequence of recurring transactions. For example, for a sequence of monthly recurring transactions, the time window for the subsequent transaction to occur can be 25 days to 35 days after the most recent transaction. Details about generating the time window based on the rate of recurrence of the sequence can be found below with respect to FIG. 2.

Predictor 122 can include a gradient-boosted tree classifier, a gradient-boosted machine classifier, or other classification models such as a logistic regression, a support vector machine, a neural network, and/or the like. In some examples, predictor 122 is trained before deployment. Details regarding training predictor 122 can be found below with respect to FIG. 2.

In some examples, predictor 122 performs batch predictions for a plurality of sequences of recurring transactions in advance (e.g., within a period), and the batch predictions can be stored in a database beforehand. For example, some sequences of monthly recurring transactions can be predicted by predictor 122 in a period (e.g., July) to have subsequent transactions in the upcoming period (e.g., August). Accordingly, batch predictions associated with the sequences predicted to have a subsequent transaction can be stored in a database once they are generated.

In some examples, the current transaction does not have a corresponding sequence of recurring transactions, and the current transaction is regarded as a standalone transaction or the starting transaction of a new sequence.

The prediction and current transaction data 112 can be provided as inputs to sequence matcher 124. Sequence matcher 124 can identify a sequence of recurring transactions corresponding to the current transaction, using, for example, identifiers related to the user (e.g., the user ID), the payee (e.g., the payee ID), and the amount of the transaction. For example, a current transaction can share the same user, the same payee, and the same amount of the transaction with the associated sequence of recurring transactions. Following the example above, after receiving the current transaction, sequence matcher 124 can retrieve batch predictions in the previous period from the database, and identify a sequence corresponding to the current transaction based on the batch predictions. In some examples, there is no corresponding sequence for the current transaction, and the current transaction is regarded as not part of a sequence and excluded from further operations.

Sequence matcher 124 can then determine whether the current transaction is within the time window specified for the corresponding subsequent transaction in the sequence of recurring transactions (e.g., based on one or more timestamps of the current transaction). If the current transaction is within the time window, the current transaction can be indicated by sequence matcher 124 as the subsequent transaction for the corresponding sequence of recurring transactions. Conversely, if the current transaction is not within the time window, the current transaction can be determined as not part of the corresponding sequence, and excluded from further operations.

In some examples, the current transaction, if indicated as the subsequent transaction of the corresponding sequence, can be combined with recurring transactions of the corresponding sequence and used as training data to retrain predictor 122, allowing predictor 122 to be continuously improved.

Future transaction creator 126 can take the indication as the input and automatically create one or more future recurring transactions 130. The automatically created one or more future recurring transactions 130 can have an identical payee, an identical transaction amount, and an identical or similar rate of recurrence as a given transaction in the sequence.

In some examples, future transaction creator 126 can recommend, to the user, automatic creation of the one or more future recurring transactions and receive, from the user, a response to the recommendation (e.g., acceptance from the user). Accordingly, future transaction creator 126 can automatically create the one or more future recurring transactions further based on the response to the recommendation.

### Example Model Trainer for Automatically Creating Recurring Transactions

FIG. 2 depicts an example model trainer 200 for automatically creating recurring transactions. Model trainer 200 can be used to train a machine learning model, such as predictor 122 as shown in FIG. 1. Model trainer 200 can receive as inputs historical transaction data 210 and generates as output trained machine learning model 230.

Historical transaction data 210 can indicate one or more historical sequences of recurring transactions, such as in the form of electronic transaction records. Historical transaction data 210 can indicate, for each historical sequence, information such as a user (e.g., through a user ID), a payee (e.g., through a payee ID), an amount of the transaction, and/or timestamps of the transactions, similar to as discussed above with respect to in FIG. 1. In some examples, each historical sequence includes two or more recurring transactions.

Historical transaction data 210 can be provided to time window generator 220. Time window generator 220 can first compute, for each historical sequence, a rate of recurrence. For example, a distribution of temporal intervals between consecutive transactions in the sequence can be generated. Accordingly, a rate of occurrence for the sequence can be estimated based on the distribution of temporal intervals.

In some examples, a desirable rate of recurrence for is determined, where the desirable rate of recurrence is within a particular range. In one example, to train a machine learning model predicting monthly sequences, the desirable rate of recurrence can be once every 25 days to once every 35 days. Accordingly, historical sequences without a desirable rate of recurrence are excluded from further operations.

Time window generator 220 can then generate, for each historical sequence (or for all the historical sequences if all the historical sequences have a desirable rate of recurrence), a time window associated with the sequence based on the rate of recurrence of the sequence. Time window generator 220 can include a rule-based decision tree or a machine learning model capable of solving regression tasks. Time windows can indicate a lower bound and an upper bound for a subsequent transaction to occur for the sequence.

Historical sequences of recurring transactions and their associated time windows can be provided as inputs to a data loader 222. Data loader can separate the historical sequences into training data and labeling data based on a cutoff time. Transactions before the cutoff time can be designated as training data while transactions after the cutoff time as labeling data. For example, a historical sequence can have 3 recurring transactions, including a first one on July 31, a second one on August 31, and a third one on September 30. A cutoff time of September 1 can help designate the first two transactions as training data, and the third transaction on September 30 as labeling data. In some examples, there is no transaction after a cutoff time, and the labeling data is null.

Data loader 222 can then generate labels for each historical sequence based on the labeling data. A binary label (e.g., 1 for positive and 0 for negative) can be generated for each historical sequence, based on whether the labeling data exists (e.g., is not null) and whether the labeling data is within the time window associated with the sequence. A positive label can be generated only if the labeling data exists and the labeling data occurs within the time window. For example, if a historical sequence has null labeling data or the labeling data does not occur during the time window, the label generated for the sequence will be negative. The labels and the corresponding historical sequences can be combined into labeled training data.

In some examples, data loader 222 can divide labeled training data into a training set, a validation set and/or a testing set. The training set can be used to train a machine learning model, the validation set to prevent overfitting of the machine learning model, and the testing set to evaluate the performance (e.g., accuracy, precision, recall, and so on) of the machine learning model.

Labeled training data can be provided as inputs to feature generator 224 to generate a set of features for each historical sequence. Feature generator 224 can be the same as or similar to feature generator 120 as shown in FIG. 1 while the set of features can include deltas between timestamps of consecutive transactions of the sequence of recurring transactions, deltas between due dates of consecutive transactions of the sequence of recurring transactions, statistical moments (e.g., mean, variance, skewness, kurtosis, and so on) of the deltas, periodic characteristics of the transactions (e.g., indications whether a transaction is created at the beginning of a period or at the end of a period) of the sequence of recurring transactions, an industry to which the payee belongs, a number of sequences associated with the payee, a standard deviation of scaled (e.g. normalized with respect to the period) timestamps of transactions of the sequence of recurring transactions, a number of transactions in the sequence of recurring transactions, a normalized standard deviation of the deltas between timestamps of consecutive transactions of the sequence of recurring transactions, and a duration between an earliest transaction and a latest transaction in the sequence of recurring transactions, and so on, the same as or similar to as discussed with respect to FIG. 1.

The set of features and the labels can be provided as inputs to predictor trainer 226 to train a machine learning model to predict, for each historical sequence, whether a subsequent transaction will occur within the pre-determined time window associated with the sequence. The machine learning model can include a gradient-boosted tree classifier, a gradient-boosted machine classifier, or other classification models. During training, predictor trainer 226 can iteratively adjust one or more parameters of the machine learning model based on the training set.

In some embodiments, the machine learning model is trained through a supervised learning process that involves providing training features as inputs to the machine learning model. Machine learning model processes the training features and outputs predictions. The predictions are compared to the labels associated with the training features to determine the accuracy of the machine learning model, and parameters of the machine learning model are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the predictions produced by the machine learning model based on the training features match the labels associated with the training features or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and the like. In some embodiments, validation and testing are also performed for the machine learning model, such as based on validation data and test data, as is known in the art.

Trained machine learning model 230 can be generated by predictor trainer 226 at the end of the training and can be used in predictor 122 as shown in FIG. 1.

### Example Features for Automatically Creating Recurring Transactions

FIG. 3 depicts example features 300 for automatically creating recurring transactions. Features 300 can be a subset of the set of features generated by a feature generator, such as feature generator 120 as shown in FIG. 1 or feature generator 224 as shown in FIG. 2. Although features 300 are depicted as associated with specific weights, the weights can be different using different training data or with different training parameters (e.g., hyperparameters indicating specific approaches during training). In this example, the period is a month (30 days) and the durations and differences are measured in days.

Feature 310a (e.g., with feature name “create_circular_std”) can be an example of the standard deviation of scaled timestamps of transactions of the sequence. In this example, the scaled timestamps are creation timestamps. The timestamps can be scaled with respect to a circle representing one period (e.g., as a function of x, such as a sinusoidal function or a complex number). Accordingly, the temporal variations can be correctly normalized. For example, a transaction created slightly earlier than the beginning of a current period (e.g., at the end of the previous period) can be correctly identified as an early transaction for the current period rather than a late transition for the previous period.

Feature 310b (e.g., with feature name “seq_size”) can be an example of the number of transactions in the sequence of recurring transactions.

Feature 310c (e.g., with feature name “sem”) can be an example of the normalized standard deviation of the deltas between timestamps of consecutive transactions of the sequence of recurring transactions. In this example, the timestamps are creation timestamps. Feature 310c can be the standard deviation of the deltas normalized by the number of transactions in the sequence.

Feature 310d (e.g., with feature name “days_from_split_max”) can be an example of the duration between an earliest transaction and a latest transaction in the sequence of recurring transactions.

Feature 310e (e.g., with feature name “create_diff_kurt”) can be an example of one of the statistical moments of the deltas. In this example, the timestamps are creation timestamps and the statistical moment is the kurtosis.

Feature 310f (e.g., with feature name “ind_code”) can be an example indication of the industry to which the payee belongs. In this example, the indication is an industry code, which can be a custom designed code, such as the North American Industry Classification System (NAICS) code.

Feature 310g (e.g., with feature name “name_id_nunique”) can be an example of information about the number of sequences associated with the payee. In this example, particularly, feature 310g represents the number of unique payees (e.g., users) that the payee indicated in a transaction associates with, which can be generated by aggregating the number of sequences associated with the payee by the unique users.

Although in this example features 310a-g depicted have a significant combined impact in a machine learning model (e.g., with a combined feature weight greater than 0.62), each of features 310a-g can be more or less significant if new training data is used, new training parameters are specified, or with a different machine learning model.

### Example Operations for Automatically Creating Recurring Transactions

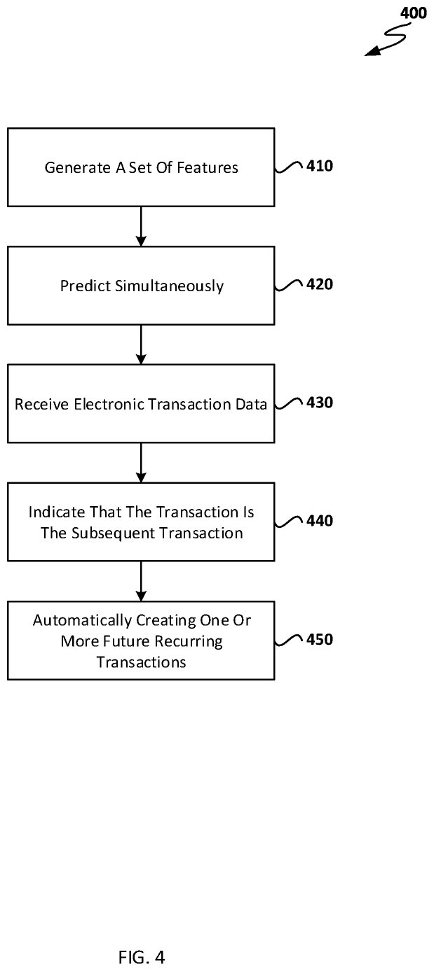

FIG. 4 is a flow diagram of example operations 400 for automatically creating recurring transactions. Operations 400 may be performed by a transaction creator, such as transaction creator 100 as illustrated in FIG. 1.

Operations 400 begin at 410, where a set of features is generated based on a sequence of recurring transactions associated with a user, a payee, and a transaction amount. For example, the set of features can be generated using feature generator 120 as illustrated in FIG. 1. In some embodiments, the set of features include deltas between timestamps of consecutive transactions of the sequence of recurring transactions, deltas between due dates of consecutive transactions of the sequence of recurring transactions, statistical moments of the deltas, periodic characteristics of the transactions of the sequence of recurring transactions, an industry to which the payee belongs, a number of sequences associated with the payee, a standard deviation of scaled timestamps of transactions of the sequence of recurring transactions, a number of transactions in the sequence of recurring transactions, a normalized standard deviation of the deltas between timestamps of consecutive transactions of the sequence of recurring transactions, and a duration between an earliest transaction and a latest transaction in the sequence of recurring transactions, and so on.

At 420, that the sequence of recurring transactions will continue with a subsequent transaction and that a time window within which the subsequent transaction of the sequence will occur are predicted simultaneously using a machine learning model based on the set of features. For example, the prediction can be performed by predictor 122 as illustrated in FIG. 1. In other words, predictor 122 can predict whether the sequence of recurring transactions will have a subsequent transaction occurring within a time window. In some embodiments, predictor 122 includes a gradient-boosted tree classifier, a gradient-boosted machine classifier, or other classification models such as a logistic regression, a support vector machine, a neural network. In some embodiments, the time window is associated with the rate of occurrence of the sequence of recurring transactions.

At 430, electronic transaction data indicative of a transaction associated with the user, the payee, and the transaction amount is received. For example, electronic transaction data can be current transaction data 112 as illustrated in FIG. 1.

At 440 that the transaction is the subsequent transaction in the sequence of recurring transactions is indicated based on the transaction and the prediction. For example, indication can be generated by sequence matcher 124 as illustrated in FIG. 1.

At 450, one or more future recurring transactions are automatically created based on the indication. For example, the one or more future recurring transactions can be automatically created by future transaction creator 126 as illustrated in FIG. 1. In some embodiments, the automatically created one or more future recurring transactions have an identical payee, an identical transaction amount, and an identical or similar rate of recurrence as a given transaction in the sequence. In some embodiments, automatic creation of the one or more future recurring transactions is recommended to the user, and a response from the user to the recommendation is received, wherein automatically creating the one or more future recurring transactions based on the indication is further based on the response to the recommendation.

### Example Application Server

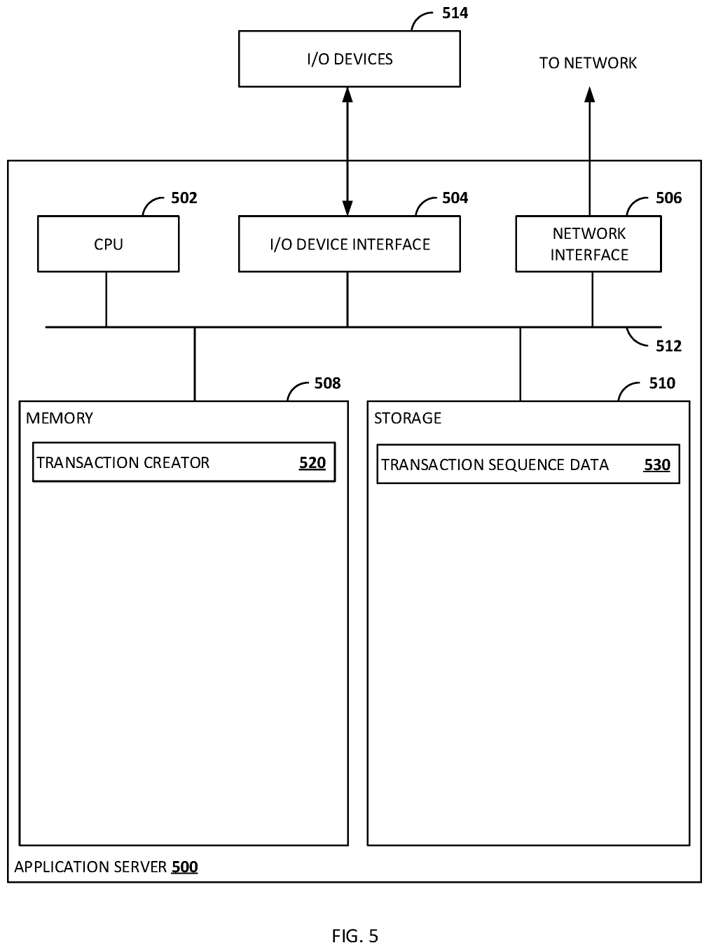

FIG. 5 depicts an example application server 500, which can be used to deploy transaction creator 100 of FIG. 1. As shown, application server 500 includes a central processing unit (CPU) 502, one or more input/output (I/O) device interfaces 504, which may allow for the connection of various I/O devices 514 (e.g., keyboards, displays, mouse devices, pen input, etc.) to application server 500, a network interface 506, a memory 508, a storage 510, and an interconnect 512.

CPU 502 may retrieve and execute programming instructions stored in memory 508. Similarly, CPU 502 may retrieve and store application data residing in memory 508. Interconnect 512 transmits programming instructions and application data, among CPU 502, I/O device interface 504, network interface 506, memory 508, and storage 510. CPU 502 is included to be representative of a single CPU, multiple CPUs, a single CPU having multiple processing cores, and the like. I/O device interface 504 may provide an interface for capturing data from one or more input devices integrated into or connected to application server 500, such as keyboards, mice, touchscreens, and so on. Memory 508 may represent a random access memory (RAM), while storage 510 may be a solid state drive, for example. Although shown as a single unit, storage 510 may be a combination of fixed and/or removable storage devices, such as fixed drives, removable memory cards, network attached storage (NAS), or cloud-based storage. In some embodiments, storage 510 is an example of the database discussed with respect to FIG. 1.

As shown, memory 508 includes transaction creator 520. Predictive system 520 may be the same as or substantially similar to transaction creator 100 of FIG. 1.

As shown, storage 510 includes transaction sequence data 530. Transaction sequence data 530 may be the same as or substantially similar to transaction sequence data 110 of FIG. 1.

It is noted that the components depicted in application server 500 are included as examples, and other types of computing components may be used to implement techniques described herein. For example, while memory 508 and storage 510 are depicted separately, components depicted within memory 508 and storage 510 may be stored in the same storage device or different storage devices associated with one or more computing devices.

### ADDITIONAL CONSIDERATIONS

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with the language of the claims.

Within a claim, reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

1. A method, comprising:
generating a set of features based on a sequence of recurring transactions associated with a user, a payee, and a transaction amount;
performing simultaneously, using a machine learning model based on the set of features:
a classification task to predict that the sequence of recurring transactions will continue with a subsequent transaction; and
a regression task to predict a time window within which the subsequent transaction of the sequence will occur;
receiving electronic transaction data indicative of a transaction associated with the user, the payee, and the transaction amount;
indicating that the transaction is the subsequent transaction in the sequence of recurring transactions based on the transaction, the classification task, and the regression task; and
automatically creating one or more future recurring transactions based on the indication, wherein:
the indication is used to retrain the machine learning model through a supervised learning process based on a training data set;
the training data set comprises respective features of transactions from before a cutoff time and binary labels indicating whether one or more transactions from after the cutoff time occurred within a corresponding time window; and
the training data set is constructed based on determining a rate of recurrence of a transaction sequence using a distribution of temporal intervals between consecutive transactions in the transaction sequence and excluding the transaction sequence from the training data set based on the rate of recurrence falling outside of a particular range.

2. The method of claim 1, wherein the set of features comprises one or more of:
deltas between timestamps of consecutive transactions of the sequence of recurring transactions;
deltas between due dates of consecutive transactions of the sequence of recurring transactions;
statistical moments of the deltas;
periodic characteristics of the transactions of the sequence of recurring transactions;
an industry to which the payee belongs;
a number of sequences associated with the payee;
a standard deviation of scaled timestamps of transactions of the sequence of recurring transactions;
a number of transactions in the sequence of recurring transactions;
a normalized standard deviation of the deltas between timestamps of consecutive transactions of the sequence of recurring transactions; and
a duration between an earliest transaction and a latest transaction in the sequence of recurring transactions.

3. The method of claim 1, wherein the machine learning model comprises one or more of a gradient-boosted tree or a gradient-boosted machine.

4. The method of claim 1, wherein the time window is based on a rate of recurrence of the sequence of recurring transactions.

5. The method of claim 1, wherein the automatically created one or more future recurring transactions have an identical payee, an identical transaction amount, and an identical or similar rate of recurrence as a given transaction in the sequence.

6. The method of claim 1, further comprising:
recommending, to the user, automatic creation of the one or more future recurring transactions; and
receiving, from the user, a response to the recommendation, wherein automatically creating the one or more future recurring transactions based on the indication is further based on the response to the recommendation.

7. A method, comprising:
receiving historical electronic transaction data indicative of one or more historical sequences of recurring transactions, wherein each sequence of the one or more historical sequences indicates a user, a payee, and a transaction amount, and wherein each sequence comprises two or more recurring transactions;
constructing a training data set based on the one or more historical sequences of recurring transactions, wherein a sequence of the one or more historical sequences of recurring transactions is included in the training data set based on a rate of recurrence associated with the sequence falling within a particular range; and
training a machine learning model through a supervised learning process based on the training data set, wherein each training data instance in the training data set comprises:
respective features of one or more transactions from before a given cutoff time; and
a corresponding binary label indicating whether one or more transactions from after the given cutoff time occurred within a corresponding time window.

8. The method of claim 7, wherein constructing the training data set based on the one or more historical sequences of recurring transactions comprises:
for each historical sequence:
determining a cutoff time;
designating the most recent transaction after the cutoff time in the sequence as labeling data and the other transactions in the sequence as training data;
determining a binary label for the sequence, based on whether the labeling data exists and whether the labeling data is within a time window associated with the sequence;
generating a set of features based on the training data set; and
combining the set of features and the binary label as the training data set.

9. The method of claim 8, wherein the set of features comprises one or more of:
deltas between timestamps of consecutive transactions of the sequence;
deltas between due dates of consecutive transactions of the sequence;
statistical moments of the deltas;
periodic characteristics of the transactions of the sequence;
an industry to which the payee belongs;
a number of sequences associated with the payee;
a standard deviation of scaled timestamps of transactions of the sequence;
a number of transactions in the sequence;
a normalized standard deviation of the deltas between timestamps of consecutive transactions of the sequence; and
a duration between an earliest transaction and a latest transaction in the sequence.

10. The method of claim 7, further comprising:
computing a rate of recurrence for each historical sequence; and
excluding sequences without a desirable rate of recurrence, wherein a desirable rate of recurrence comprises a given rate of recurrence within a particular range.

11. The method of claim 7, wherein the machine learning model comprises one or more of a gradient-boosted tree or a gradient-boosted machine.

12. A system, comprising:
a memory including computer executable instructions; and
a processor configured to execute the computer executable instructions and cause the system to:
generate a set of features based on a sequence of recurring transactions associated with a user, a payee, and a transaction amount;
perform simultaneously, using a machine learning model based on the set of features:
a classification task to predict that the sequence of recurring transactions will continue with a subsequent transaction; and
a regression task to predict a time window within which the subsequent transaction of the sequence will occur;
receive electronic transaction data indicative of a transaction associated with the user, the payee, and the transaction amount;
indicate that the transaction is the subsequent transaction in the sequence of recurring transactions based on the transaction, the classification task, and the regression task; and
automatically create one or more future recurring transactions based on the indication, wherein:
the indication is used to retrain the machine learning model through a supervised learning process based on a training data set;
the training data set comprises respective features of transactions from before a cutoff time and binary labels indicating whether one or more transactions from after the cutoff time occurred within a corresponding time window; and
the training data set is constructed based on determining a rate of recurrence of a transaction sequence using a distribution of temporal intervals between consecutive transactions in the transaction sequence and excluding the transaction sequence from the training data set based on the rate of recurrence falling outside of a particular range.

13. The system of claim 12, wherein the set of features comprises one or more of:
deltas between timestamps of consecutive transactions of the sequence of recurring transactions;
deltas between due dates of consecutive transactions of the sequence of recurring transactions;
statistical moments of the deltas;
periodic characteristics of the transactions of the sequence of recurring transactions;
an industry to which the payee belongs;
a number of sequences associated with the payee;
a standard deviation of scaled timestamps of transactions of the sequence of recurring transactions;
a number of transactions in the sequence of recurring transactions;
a normalized standard deviation of the deltas between timestamps of consecutive transactions of the sequence of recurring transactions; and
a duration between an earliest transaction and a latest transaction in the sequence of recurring transactions.

14. The system of claim 12, wherein the machine learning model comprises one or more of a gradient-boosted tree or a gradient-boosted machine.

15. The system of claim 12, wherein the time window is based on a rate of recurrence of the sequence of recurring transactions.

16. The system of claim 12, wherein the automatically created one or more future recurring transactions have an identical payee, an identical transaction amount, and an identical or similar rate of recurrence as a given transaction in the sequence.

17. A non-transitory computer readable medium comprising instructions to be executed in a computer system, wherein the instructions when executed in the computer system cause the computer system to:
generate a set of features based on a sequence of recurring transactions associated with a user, a payee, and a transaction amount;
perform simultaneously, using a machine learning model based on the set of features:
a classification task to predict that the sequence of recurring transactions will continue with a subsequent transaction; and
a regression task to predict a time window within which the subsequent transaction of the sequence will occur;
receive electronic transaction data indicative of a transaction associated with the user, the payee, and the transaction amount;
indicate that the transaction is the subsequent transaction in the sequence of recurring transactions based on the transaction, the classification task, and the regression task; and
automatically create one or more future recurring transactions based on the indication, wherein:
the indication is used to retrain the machine learning model through a supervised learning process based on a training data set;
the training data set comprises respective features of transactions from before a cutoff time and binary labels indicating whether one or more transactions from after the cutoff time occurred within a corresponding time window; and
the training data set is constructed based on determining a rate of recurrence of a transaction sequence using a distribution of temporal intervals between consecutive transactions in the transaction sequence and excluding the transaction sequence from the training data set based on the rate of recurrence falling outside of a particular range.

18. The non-transitory computer readable medium of claim 17, wherein the set of features comprises one or more of:
deltas between timestamps of consecutive transactions of the sequence of recurring transactions;
deltas between due dates of consecutive transactions of the sequence of recurring transactions;
statistical moments of the deltas;
periodic characteristics of the transactions of the sequence of recurring transactions;
an industry to which the payee belongs;
a number of sequences associated with the payee;
a standard deviation of scaled timestamps of transactions of the sequence of recurring transactions;
a number of transactions in the sequence of recurring transactions;
a normalized standard deviation of the deltas between timestamps of consecutive transactions of the sequence of recurring transactions; and
a duration between an earliest transaction and a latest transaction in the sequence of recurring transactions.

19. The non-transitory computer readable medium of claim 17, wherein the machine learning model comprises one or more of a gradient-boosted tree or a gradient-boosted machine.

20. The non-transitory computer readable medium of claim 17, wherein the time window is based on a rate of recurrence of the sequence of recurring transactions.
